(19) United States
(12) Patent Application Publication
(10) Pub. No.: US 2007/0267399 A1
(43) Pub. Date: Nov. 22, 2007

(54) Table-heater combination

(76) Inventor: Amal Flores, Los Angeles, CA (US)

Correspondence Address: CARLOS CANDELORO, 1601 N. SEPULVEDA BLVD., # 239, MANHATTAN BEACH, CA, 90266, US

(21) Appl. No.: 11/438,085

(22) Filed: May 18, 2006

(51) Int. Cl. H05B 3/00

(52) U.S. Cl. 219/218

(57) ABSTRACT

A table-heater combination includes a table and a heater attached to or integrally formed with the table such as to provide heat under the table.

### FIELD OF THE INVENTION

The present invention relates to the field of furniture and ambient heaters.

### BACKGROUND OF THE INVENTION

It is common for gathering places, including restaurants, bars and residences to have outdoor patios that are uncomfortably cold during certain times of the day or year. Gas fired infrared heaters have become common for heating these exposed or outdoor areas. These heaters are generally elevated on a post or standard above the head of the persons to be warmed by the infrared radiation. For example, U.S. Pat. No. 6,192,878 discloses a patio heater that radiates infrared heat with a system that is meant to maximize the amount of heat that is directed in a generally downward direction. See also U.S. Pat. Nos. D429,324, D462,426 and D325,963.

Despite their commercial success, overhead heaters present several disadvantages. For example, unless elevated to a considerable height these heaters tend to make a person's head uncomfortably warm. Because they must be placed at a considerable height, most of the heat generated by these heaters is lost, dissipated above the crowd, thus forcing people to gather around the heater. For those wearing shorts, skirts or open shoes, the heat generated by overhead heaters never gets to where it is needed. In addition, these heaters are generally mounted on unsightly posts that create aesthetically unpleasant visual clutter.

Table-heater combinations are known, see, e.g., U.S. Pat. No. 6,192,878 FIGS. 11 and 12, D462,427, D462,426 and D456,498. However the designs disclosed invariably have the heater over the table, and thus present the same disadvantages as regular patio heaters. The same shortcomings are present in “table top” heaters, see, e.g., U.S. Pat. Nos. D466,993 and D509,291.

### SUMMARY OF THE INVENTION

In a first, separate aspect of the present invention, a heater includes a mounting element adapted to mount said heater to the leg of a table.

In a second, separate aspect of the present invention, a heater includes a mounting element adapted to mount said heater to the under side of a table top.

In a third, separate aspect of the present invention, a table heater combination includes a table and a heater. The table includes a table top supported by one or more legs. The heater is mounted on one or more of said legs.

In a fourth, separate aspect of the present invention, a table heater combination includes a table and a heater. The table includes a table top supported by one or more legs. The heater is integrally formed with on one or more of said legs.

In a fifth, separate aspect of the present invention, a table heater combination includes a table and a heater. The table includes a table top supported by one or more legs. The table top includes a top-side and an under-side. The heater is mounted on the under-side of the table top.

In a sixth, separate aspect of the present invention, a table heater combination includes a table and a heater. The table includes a table top supported by one or more legs. The table top includes a top-side and an under-side. The heater is integrally formed with the under-side of the table top.

In a seventh, separate aspect of the present invention, in a table heater combination, the improvement comprising mounting a heater on a table such that the heater is positioned under the table.

In an eight, separate aspect of the present invention, in a table heater combination, the improvement comprising integrally forming a heater as part of a table such that the heater is positioned under the table.

In a ninth, separate aspect of the present invention, a method for providing ambient heat includes a) providing a table heater combination in accordance with an embodiment of the present invention, b) connecting the heater to an effective power source, c) powering said heater on.

BRIEF DESCRIPTION OF THE DRAWINGS

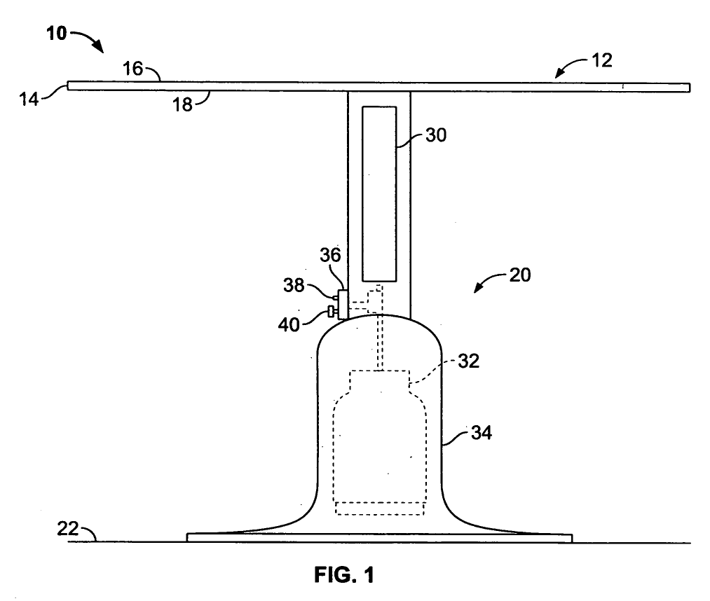

FIG. 1 is a front view of a table-heater combination according to an embodiment of the present invention.

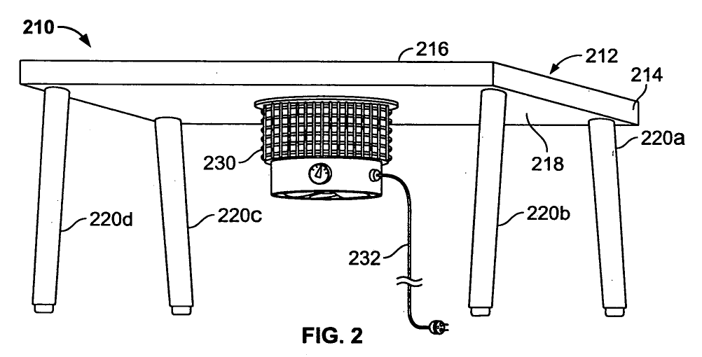

FIG. 2 is a front view of a table-heater combination according to another embodiment of the present invention.

### DETAILED DESCRIPTION OF THE PREFERRED EMBODIMENTS

Turning in detail to the drawings, where like reference characters designate like parts, a table-heater combination 10 is illustrated in FIG. 1. The table 12 includes a table top 14 having a top side 16 and an under side 18. The table 12 generally includes a leg, support 20, or the like, that maintains the table top 14 elevated off the floor in a substantially or generally horizontal position. A base 22 may be provided for stability of the table 12. A heating element 30, or the like, or a housing containing a heating element, or the like, is advantageously positioned in any effective position and manner such that hot air and/or heat generated by it will be generated, produced, radiate, or the like, under the table 12 or from under the table 12.

The heating element, or the like, or a housing containing a heating element, or the like, may be secured or attached to the table 12 in any effective manner. In one embodiment, shown in FIG. 1, a housing containing a heating element 30 is integrally formed, or the like, with a table support 20. Alternatively, for example, the heating element or housing containing a heating element may adapted to be mounted, and mounted onto, a support of a table with a mounting bracket, or the like, or the heating element or housing containing a heating element may be soldered, bolted onto, riveted, or the like, onto the support, integrally formed therewith, or the like, or otherwise attached thereto in any effective manner.

The heating element 30 is generally powered by a fuel source or power supply. The type of fuel source or power supply will, of course, depend on the type of heating element used, and may include, for example, an electric outlet, or the like, for electric heaters; a propane tank, or the like, or a connection to a gas line, or the like, for liquid propane and/or natural gas fueled heaters; kerosene, diesel, or the like, for kerosene fueled heaters. In the embodiment shown in FIG. 1, a fuel source 32, liquid propane tank, or the like, is housed 34 within the support 20. A control box 36 has controls for controlling the heating element 30. The control box 36 may also include controls for controlling the amount of heat generated by the heating element 30. A thermostat, or the like, may also be included. In the case of a propane and/or natural gas heater the arrangement may include an igniter 38 and a regulator 40, gas valve control, or the like.

FIG. 2 illustrates another embodiment of a table heater combination 210 in accordance with the present invention. The table 212 includes a table top 214 having a top side 216 and an under side 218. The table 212 includes legs, supports 220 (a, b, c and d), or the like, that maintain the table top 214 elevated off the floor and in a substantially or generally horizontal position. A heater 230, or the like, is advantageously positioned in any effective place and manner such that the hot air and/or heat generated by it will be generated, produced, radiate, or the like, under the tabletop 214 or from under the tabletop 214. The heater 230, for example, may be adapted to be mounted onto the under-side 218 of a table top 214 with a mounting bracket, or the like. Alternatively, the heater 230 may be soldered, bolted onto, riveted, or the like, onto the under-side 218 of a table top 214, integrally formed therewith, or the like, or otherwise attached thereto in any effective manner. A power-cord 232, or the like, adapted to be plugged into a power outlet powers the heater 230. A control box or the like generally is also present.

In other embodiments (not shown) the heater is attached, or the like, or integrally formed, or the like, to both the table top and one or more of the table supports.

While the figures illustrate two embodiment of the present invention, the present invention is not limited to any specific type of table. The present invention may be used with any effective type of table, desk, or the like. The table is preferably made of one or more materials resistant to the amount of heat it may be subjected to when the heater is on. In one embodiment, the table top includes an insulating material, which prevents the table top from becoming uncomfortably warm.

Heaters are well known in the art. (See, e.g., U.S. Pat. Nos. 1,429,130, 2,255,759, 2,375,920, 2,471,784, 2,824,429, 3,175,550, 3,251,356, 3,267,255, 3,575,582, 3,725,640, 3,862,820, 3,981,674, 4,004,128, 4,197,447, 4,703,152, 4,743,739, 4,755,653, 4,900,898, 4,963,716, 5,083,011, 5,192,853, 5,245,691, 5,278,936, 5,381,50, 5,434,386, 5,437,001, 5,565,855, 5,663,633, 5,761,377, 5,814,792, 6,192,878, 6,321,034, 6,466,737, 6,480,672, 6,624,397, 6,704,497, 6,901,213, 6,980,079, all of which are incorporated herein by reference as if fully set forth herein.) Any effective heater may be used in accordance with the present invention. An effective heater is a heater that can provide any form of heat while being safe and not so hot as to cause injury to those sitting at the table-heater combination when it is being used as intended. Advantageously, the heater may be less powerful, and thus consume less energy, than commercially available heaters intended for similar areas. The heater in accordance with the present invention may have any effective power output. For example, the heater may be rated within the range of from about 100 watts to about 1500 watts. In one embodiment, the heater is rated at about 300 W. In another embodiment, the heater is rated at about 500 W. In another embodiment, the heater is rated at about 800 W. In another embodiment, the heater is rated at about 1000 W. Effective heaters include, for example, electric heaters, baseboard, ceramic, parabolic and oil filled heaters, electric oil filled radiators, gas (including natural gas and/or propane) powered heaters and infra-red radiating heaters, kerosene heaters, and the like. A heater to be used in accordance with another embodiment of the present invention may further include one or more fans to generate a flow of air.

A heater to be used in accordance with an embodiment of the present may provide heat in any effective direction, including 360 degrees or directionally. If a 360 degrees heater is used, in accordance with another embodiment of the present invention controls may be present to control the amount of heat radiated, given off, or the like, in different directions.

If one or more directional heaters are employed, in accordance with another embodiment of the present invention each may face a predetermined direction or they may be pivotally mounted such that the directionality can be changed, and each heater may additionally be individually controlled to regulate the amount of heat radiated or produced in a particular direction. In another embodiment, the heater includes “cool to the touch” housing.

A table-heater combination in accordance with the present invention provides several advantages. In one embodiment, in the table heater combination of the present invention the table top prevents hot air and/or heat from directly rising and/or escaping from the area in which it is most effective. In another embodiment, a cushion of hot air and/or heat is formed under the table by a table-heater combination in accordance with an embodiment of the present invention. In another embodiment, positioning the heater in accordance with the present invention provides a flow of hot air and/or heat on the under side of the table from the middle of the table to the edge of the table and then up, over the table, forcing the flow of hot air and/or heat to traverse the length of a body sitting at the table-heater combination. In accordance with another embodiment, the table-heater combination in accordance with the present invention provides a warm table top, thus providing warmth and/or radiating heat on the upper side of the table. In accordance with another embodiment, a table-heater combination in accordance with the present invention, in particular when the table top has holes in it, provides a flow of hot air and/or heat thru the table top, onto the upper side of the table. In this latter embodiment, the amount of hot air and/or heat that flows thru the table may be modified or optimized by changing or adjusting the ratio of solid surface to holes on the table top. In accordance with another embodiment of the present invention, a table-heater combination in accordance with the present invention provides heat to the lower extremities of the body. In accordance with another embodiment of the present invention, a table-heater combination in accordance with the present invention reduces power/fuel consumption. In accordance with another embodiment of the present invention, a table-heater combination in accordance with the present invention is aesthetically pleasing and avoids visual clutter.

A table heater combination in accordance with the present invention may include all those elements well known in the art to be necessary for its proper and safe use.

In use, a table heater combination of the present invention may be placed in a suitable location. The heater is connected to a power/fuel source and operated as any conventional heater.

The embodiments of the present invention are intended to be merely exemplary and those skilled in the art shall be able to make numerous variations and modifications to them without departing from the spirit of the present invention. All such variations and modifications are intended to be within the scope of the present invention as defined in the appended claims.

What is claimed is:

1. A table-heater combination comprising a table comprising a heater, wherein the heater is in a position adapted to generate heat under the table.

2. The table-heater combination of claim 1, the table further comprising a table top and a support for the table top.

3. The table-heater combination of claim 2, the support further comprising said heater.

4. The table-heater combination of claim 3, wherein the heater is mounted on said support.

5. The table of claim 3, wherein the heater is integrally formed with the support.

6. The table of claim 2, the table top comprising a top side, an under side, and the heater.

7. The table of claim 6, wherein the heater is mounted onto the underside of the table top.

8. The table of claim 6, wherein the heater is integrally formed with the table top.

9. The table of claim 8, wherein the heater is integrally formed with the underside of the table top.

10. The table of claim 1 wherein the heater is selected from the group consisting of an electric heater, a natural gas powered heater, a propane powered heater and a kerosene powered heater.

11. The table of claim 10 wherein the heater has an output within the range from about 300 watts to about 1500 watts.

12. The table of claim 10 wherein the heater is an electric heater selected from the group consisting of an oil-filled type radiator, an infrared heater, a convection heater, a radiant heater and a fan-forced heater.

13. A method for providing ambient heat comprising
a) providing a table comprising a heater, wherein the heater is in a position of the table adapted to generate heat under the table;
b) connecting the heater to an effective power source;
c) powering said heater on.

14. A table-heater combination comprising
a table top;
a leg supporting the table top;
a heater able to generate an output within the range from about 300 watts to about 1500 watts of heat;
wherein the heater is mounted on the table top and leg; and
wherein the heater is adapted to generate heat under the table.
